(19) United States
(12) Patent Application Publication
(10) Pub. No.: US 2002/0164006 A1
(43) Pub. Date: Nov. 7, 2002

(54) Electronic document call back system

(76) Inventor: Lewis E. Weiss, Boone, NC (US)

Correspondence Address: Lewis E. Weiss, Suite 816, 639 Whispering Hills Road, Boone, NC, 28607, US

(21) Appl. No.: 09/849,549

(22) Filed: May 4, 2001

(51) Int. Cl. H04M 3/42

(52) U.S. Cl. 379/201.01

(57) ABSTRACT

An Electronic Document Call Back System with custom graphic or hypertext link visual indicia which may be embedded in an electronic document by a sender of said electronic document (which may be a company), which electronic document may be sent to a recipient (which may be a customer). When clicked upon by the customer with a computer mouse or other computer pointing device, the visual indicia, which links to a Call Request Page, causes to appear on the customer's computer screen said Call Request Page. The Call Request Page may include sections upon which the customer, who wishes to communicate by phone with the company, may enter at least their phone number so that a phone communication can be created with the company, and a graphic “call” button that is viewed on the customer's computer screen. The pushing of the “call” button engages a Web server; the Web server signals a telecom switch; the telecom switch capable of calling the phone number of the company; the telecom switch also capable of calling the phone number of the customer, and bridging the two calls together so that the company and customer can talk. Said Web server is capable of sending an email to said company which will include the information which said customer has entered on the Call Request Page, which may include said customer's name, email address, phone number and the like; said Web server capable of sending said customer a “thank you” or an auto-response email. The preferred embodiment includes the ability of the company to custom design the custom graphic or hypertext link visual indicia and to embed, either by a standard “copy and paste” operation or by means of embedding said visual indicia in an email signature template, said visual indicia in an electronic document to be sent to customers.

### FIELD OF THE INVENTION

This invention relates to an Electronic Document Call Back System, and more particularly to a system providing instant availability of a call back feature from an electronic document sent to a customer or other entity.

### BACKGROUND OF THE INVENTION

Currently, in the field of live sales and customer support, a customer can go to a company's Internet World Wide Web (hereinafter called “Web”) site, and, if a call back feature is provided, as some sites have, the customer can activate that feature and be connected via telephone, Internet telephony, or on-line “chat” to a live company representative.

The foregoing feature is beneficial because it saves the customer from having to locate the proper telephone number, and from having to navigate a maze of secretaries, phone answering machines, etc., in order to get to the proper company representative.

However, the instant availability of this feature-by activating a visual “call back” indicia—is apparent to a customer only after navigating to and through an often difficult-to-navigate Web site. There may be many Web pages to go through before one reaches a call back feature.

Also, some Web sites have many different call back buttons, one for each particular company department, specific product, or service. A customer must find the proper section of the Web site with its corresponding call back button in order to reach the proper company representative. Many customers might not take the time and trouble to so navigate.

It would be desirable to inform probably far more customers of the instant availability of a call back feature through other means, in particular, through email and/or other electronic documents that are sent to the customer. The electronic document may be related to a specific product or service. If the customer feels a need to talk to a live person concerning that product or service, he or she can activate the call back feature and be connected directly to exactly the right person, with little effort involved.

There is no need to go to the Web site and search for the proper page, telephone number or call back feature. The electronic document delivers directly to the customer the instant availability of a telephone connection to the precise person or department he or she needs to talk to.

There are two categories of electronic documents that are sent to the customer: those that are sent directly and those that are sent indirectly to the customer.

Examples of electronic documents that are sent directly to the customer include, but are not limited to: “rich media” email messages; ordinary text email messages; email attachments; word processing documents; spreadsheets; databases; email software programs; Web browser software programs; sales contact management software programs; call center support software; graphic or multimedia sales presentations (for example Microsoft PowerPoint presentations), templates and software; CD ROM disks and floppy disks; multimedia CD ROM disks; Web site banner ads; and screens or instructions which may be displayed during the setup or operation of a software program, including technical service “help” screens contained within any software program.

Examples of electronic documents that are sent indirectly to the customer include, but are not limited to, screens contained within any software program which are designed to provide immediate access to technical service representatives who can provide assistance with questions of how to use a particular software program. Said screens could contain “help” buttons offering the instant availability of a telephone connection to said technical service representatives, within software programs that one obtains from a third party. In this case, the electronic documents are sent to a third party, e.g., a vendor, and then the customer obtains the electronic document from the third party (by purchasing, downloading, free distribution in the form of floppy disk, CD ROM, etc.).

A Web page can also be considered an electronic document, however a “live” Web page (i.e., one that you can interact with) cannot be sent by email. A hypertext link to the Web page or a bit-mapped graphic representation of a Web page can be sent; however, it is not possible to interact with these unless one takes the extra step of going to the actual Web page using one's Web browser software.

Please note that we have been using the term “company” to refer to the sender of an electronic document, and the term “customer” to refer to the recipient of an electronic document. However, the terms “company” and “customer” should not limit our understanding of who can send and receive an electronic document containing a call back feature.

Any entity—a company, an organization, or an individual person—can send or receive an electronic document containing a call back feature. For example, a customer who receives an electronic document with a call back feature may, in turn, find it useful to have a call back feature in his or her own personal emails that are sent to friends, family, or business associates.

### SUMMARY OF THE INVENTION

In accordance with a preferred embodiment of the invention, there is provided an Electronic Document Call Back System comprising visual indicia on a customer's (“recipient's”) computer screen that shows an electronic document (including but not limited to a “rich media” email message (whether sent individually or as one of many emails sent as part of an email marketing campaign broadcast), an “ordinary text” email message (again, whether sent individually or as one of many emails sent as part of an email marketing campaign broadcast), an email attachment, a word processing document, a spreadsheet, database, an email software program, a Web browser software programs, a sales contact management software program, a call center support software program, a graphic or multimedia sales presentation (for example Microsoft PowerPoint presentation) template and software, a CD ROM disk, a multimedia CD ROM disk, a floppy disk, a screen or instruction which may be displayed during the setup or operation of a software program, including a technical service “help” screen contained within any software program, or a Web site banner ad, the indicia indicating that activation of the indicia will initiate a telephone call back from a company (“the sender”).

Upon the activation of the indicia, a means is provided to engage a Web server for opening an inquiry on the customer's computer screen of at least the customer's telephone number. The Web server is adapted to initiate telephone communication between the company and the customer.

Since companies can economically send emails and other electronic documents to many customers, the foregoing system can inform those many customers of the instant availability of a call back feature. In this way, a company can better service its customers.

### BRIEF DESCRIPTION OF THE DRAWINGS AND NOTES

The drawings constitute a part of this specification and include exemplary embodiments to the invention, which may be embodied in various forms. It is to be understood that, in some instances, various aspects of the invention may be shown exaggerated or enlarged to facilitate an understanding of the invention.

FIG. 1: A diagram showing a comparison of the state of the art of call back systems for Web sites and the advancement in the art represented in the present embodiment of the Electronic Document Call Back System

FIG. 2: Electronic Document Call Back System—Overview: showing the Electronic Document Call Back System of the present invention.

Electronic Document Call Back System—Detailed Definitions and Notes: detailed definitions and description of the Electronic Document Call Back System of the present invention.

FIG. 3: “button clicker first” call flow: A flow chart showing the sequence of events of the system of the present invention when the “button clicker” is called first.

FIG. 4: “button owner first” call flow: A flow chart showing the sequence of events of the system of the present invention when the “button owner” is called first, which has a usefulness for the button owner, of affording to the button clicker a certain added convenience.

FIG. 5: Physical Equipment and Linkages of the Electronic Document Call Back System: A schematic diagram showing the physical equipment and their linkages which are needed to complete the Electronic Document Call Back System.

### DETAILED DESCRIPTIONS OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner.

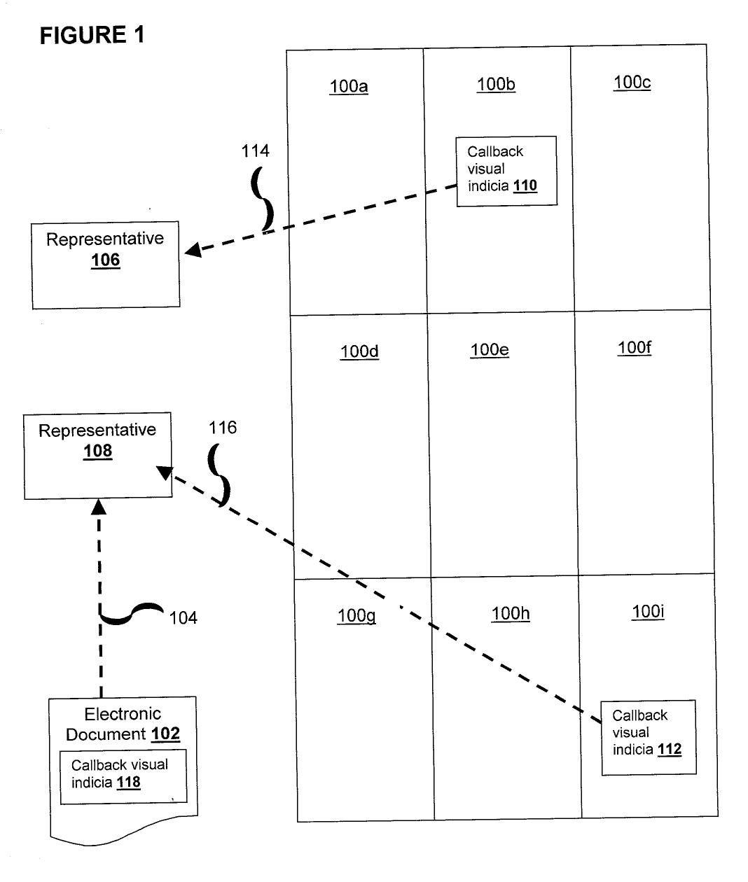

FIG. 1: A diagram showing a comparison of the state of the art of call back systems for Web sites and the advancement in the art represented in the present embodiment of the Electronic Document Call Back System.

FIG. 1 schematically illustrates a Web site 100 that may have a plurality of pages 100a-100i, and an Electronic Document 102 as would be shown on the computer screen of the recipient of the electronic document.

Web site 100 may have one or more pages, for instance, pages 100b and 100i, which state various matters (e.g., a service upgrade or a product offering). Each page may contain a call back capability.

In the current state of the art, as is typical business practice, a representative 106 for one product or service will talk with a customer, as shown by dashed line 114, who requests a call back by clicking on a visual indicia 110 on page 100b, and another representative 108 for another product or service will talk with a customer, as shown by dashed line 116, who requests a call back by clicking on a visual indicia 112 on page 100i.

In the advancement of the art represented in the present embodiment of the Electronic Document Call Back System, Electronic Document 102 may state (not shown) a specific matter (e.g., a service upgrade, a product offering) along with a visual indicia 118 (graphic button or hypertext link) offering the capability of a call back connection to representative 108, the same representative that the customer would be connected to by clicking on the visual indicia 112 on page 100i.

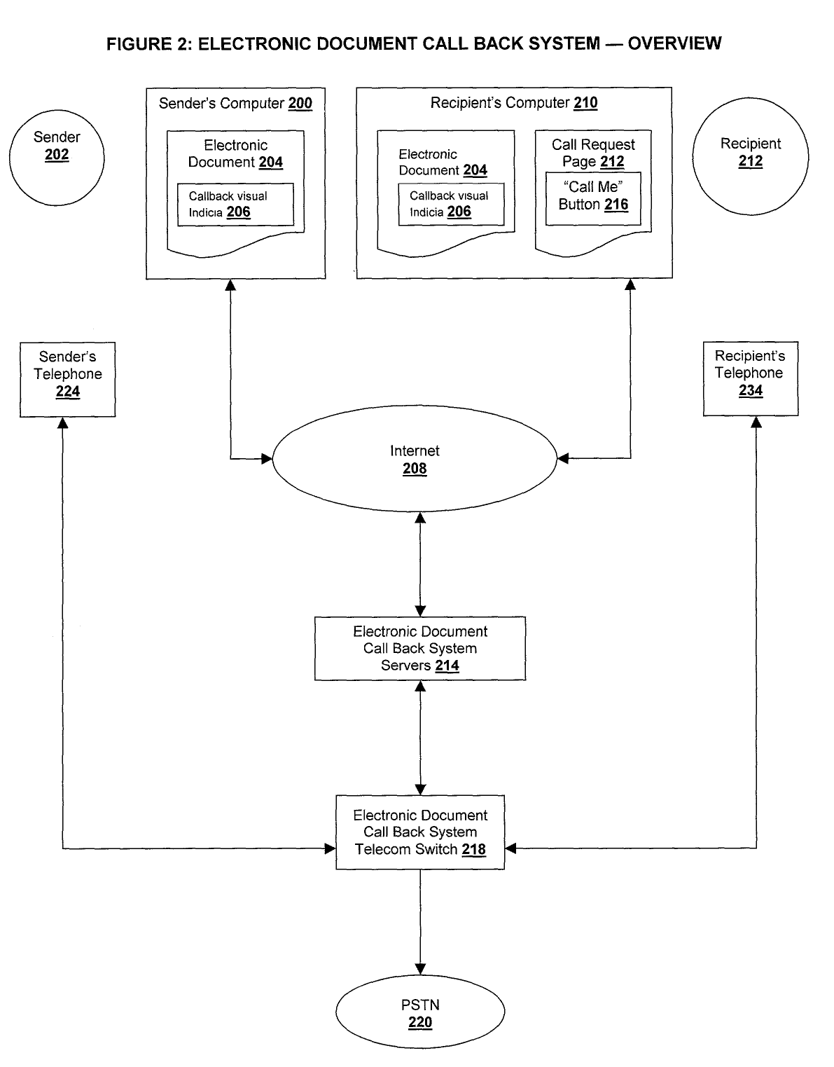

Electronic Document 102 contains a visual indicia 112 which when clicked will connect (as will be described in FIGS. 2-5 following) the customer to a specific department or representative (e.g., to representative 108) as shown by dashed line 104, so that the present embodiment will enable the recipient of the electronic document to talk directly with a person 108 in the employ of the sender of said electronic document regarding a product or service directly appropriate to the matter stated in the electronic document.

In the above described and illustrated way, the sender of an electronic document, for example a company, can allow the recipient of said electronic document, for example a customer, to be presented with the capability of talking with a person in the offices of the sender by simply clicking on a graphic button or hypertext link (visual indicia) located in an electronic document which is read by the recipient of said electronic document.

This procedure saves the recipient of said electronic document valuable time and produces a reduction of frustration in reaching a customer service representative or other person, via phone, in the offices of the sender of said electronic document.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### FIG. 2: Electronic Document Call Back System—Overview

Referring now to FIG. 2 we see a diagram overview of the Electronic Document Call Back System of the present invention. A sender (202) acquires their own unique Electronic Document Call Back System visual indicia (which may be a graphic button, a hypertext link, or the URL of a unique Call Request Page, which will be described herein) from the company providing the Electronic Document Call Back System of the present invention, and embeds or places the link as a visual indicia (206) in an electronic document (204) on his or her computer screen (200).

The visual indicia for the electronic document call back link could be, among other possibilities, a button-shaped graphic or a hypertext link. The preferred embodiment would include words on the button or text surrounding the hypertext link indicating that a telephone connection is what is to be expected from clicking on the visual indicia. The visual indicia is able to be custom designed by the sender. (The hypertext link, for example, can include the sender's name, company name, product name, or any other words that the sender desires, and can be changed easily by the sender.)

Whether it is a graphic button, a hypertext link, or a URL, in the present embodiment, the visual indicia of the sender of the electronic document links to the same Call Request Page, which will be identified with that sender. Although the Call Request Page is identified with the sender of the electronic document, each sender can have as many different Call Request Pages (and therefore visual indicia linking to each) as they wish.

The sender then sends the electronic document (204) through the Internet (208) to a recipient (212). The recipient receives the electronic document (204) and opens it on his or her computer screen (210).

When the recipient activates the visual indicia (206) by a conventional point and click method found on most computers, the browser software on the recipient's computer is automatically activated, and a signal is sent through the Internet (208) to the Electronic Document Call Back System servers (214), causing a call request page (212) to be transmitted through the Internet (208) to the recipient's computer screen (210).

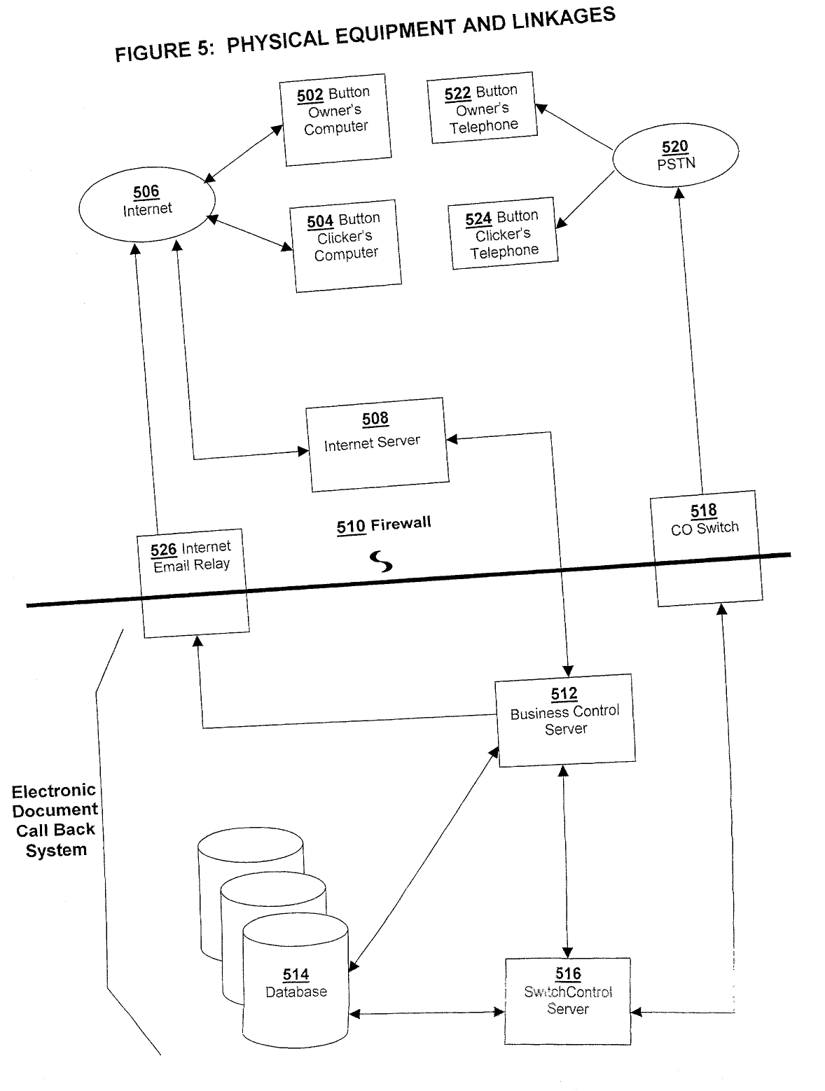

(Note: The Electronic Document Call Back System servers include an Internet server, a business control server, and a switch control server, all of which communicate with a database. For a more detailed explanation of the equipment and linkages, see FIG. 5 below.)

The recipient enters information on the call request page (212) and clicks on a send button (216), a graphic button which in the preferred embodiment may be labeled with one or more of the following or other similar phrases: “Instant Live Talk,” “Instant LiveTalk,” “Call Me,” “Call,” “Click to Call,” “Make My Phone Ring,” “Call Me Now,” “We'll Call You For Free,” “Click Here to Talk to a Live Person,” or any other words which indicate that the recipient of the electronic document is requesting to speak, or may speak, with the sender of the electronic document.

Then, the information on the call request page is transmitted through the Internet (208) to the Electronic Document Call Back System servers (214), which validate the call request and then instruct the Electronic Document Call Back System telecom switch (218) to call, through the Public Switch Telephone Network (PSTN) (220), the recipient's telephone (234) and also call the sender's telephone (224). The Electronic Document Call Back System telecom switch then bridges the two calls together so that the recipient and the sender can talk.

The Electronic Document Call Back System servers (214) send through the Internet (208) an email to the sender with the details of the call request, including the information the recipient entered in the call request page, and sends through the Internet an email to the recipient showing acknowledgement of the call request along with the optional “custom email” message which can be created by the sender.

### Electronic Document Call Back System—Detailed Definitions and Notes

Referring to FIG. 2 and the overview of the Electronic Document Call Back System above, and throughout the Detailed Descriptions of the Preferred Embodiment, the following detailed definitions apply:

Electronic Documents

Electronic documents include, but are not limited to, “rich media” email messages; ordinary text email messages; email attachments; word processing documents; spreadsheets; databases; email software programs; Web browser software programs; sales contact management software programs; call center support software; graphic or multimedia sales presentations (for example Microsoft PowerPoint presentations), templates and software; CD ROM disks and floppy disks; multimedia CD ROM disks; Web site banner ads; and screens or instructions which may be displayed during the setup or operation of a software program, including technical service “help” screens contained within any software program.

Visual Indicia

The electronic document will contain a visual indicia which, when activated, initiates the Electronic Document Call Back System. The visual indicia in the electronic document will typically be in the form of a graphic button or a hypertext link [color highlighted word combination containing the Web page address (URL) of the Call Request Page or a hypertext phrase linked to that URL].

In the preferred embodiment, the visual indicia, whether a graphic button or a hypertext link, would be able to be custom designed by the sender. (The hypertext link, for example, may be a URL containing a unique identifying number and/or letter sequence which may be personalized to include the sender's name, company name, product name, or any other words that the sender desires. It may also be a phrase which indicates that clicking on it will create a telephone connection between the recipient and the sender of the electronic document.)

This hypertext link may be a word sequence indicating that clicking upon it will create a telephone connection with the button owner, or it may be a URL containing a unique identifying number and/or letter sequence which may be customized as a name or phrase of the button owner's choice by using an Edit Page Name function of an Electronic Front Office (EFO) or other means of changing the unique identifying number and/or letter sequence in the URL of the hypertext link. The hypertext link may include the sender's name, company name, product name, or any other words that the sender desires. In the present embodiment, these customizable words may be easily changed by the sender whenever he or she desires using an “Edit Page Name” feature of an “Electronic Front Office” (an online interface for the Electronic Document Call Back System—see below).

Although the visual indicia may be a graphic button or a hypertext phrase which is linked to the URL of the Call Request Page (as described below), or it may be the URL itself, the advantage of customizing the URL of the hypertext link is that the URL can be easily embedded by the sender into an “ordinary text email” message as opposed to a graphic button or a hypertext link in a “rich media” email message which requires rich media email capability which supports HTML software code. Thus, the recipient does not need an email editor with “rich text” display capability in order to receive and respond to an electronic document containing a visual indicia in the present embodiment which takes the form of a URL which may be clicked upon by the recipient to launch a Call Request Page which corresponds to the sender, in order to activate the Electronic Document Call Back System and connect on the phone with the sender.

Whether it is a graphic button, a hypertext link, or a URL, in the present embodiment, the visual indicia of the sender of the electronic document links to the same Call Request Page, which will be identified with that sender. Although the Call Request Page is identified with the sender of the electronic document, each sender can have as many different Call Request Pages (and therefore visual indicia linking to each) as they wish.

A visual indicia contained within an electronic document may indicate with words or pictures or other graphic elements that a telephone connection is what is to be expected from clicking on the visual indicia. For example, in the present embodiment, the graphic button may be labeled with one or more of the following or other similar phrases: “Instant Live Talk,” “Instant LiveTalk,” “Call Me,” “Call,” “Click to Call” “Make My Phone Ring,” “Call Me Now,” “We'll Call You For Free,” “Click Here to Talk to a Live Person,” or any other words which indicate that the recipient of the electronic document is requesting to speak, or may speak, with the sender of the electronic document. When the visual indicia takes the form of a hypertext link, it may be surrounded by text indicating that a telephone connection is what is to be expected from clicking the visual indicia, which in the present embodiment may take the form of a phrase such as, “Click here to connect [or speak] with me now. Try it. It's a FREE call!” or some other such phrase indicating that a phone connection with the sender of the electronic document is what can be expected from clicking on the hypertext link or URL which accompanies such a phrase.

The sender of the electronic document can place the visual indicia within the electronic document at a place or places of the sender's choice. The process of placing the visual indicia within the electronic document may be automated to varying degrees by embedding the visual indicia in signature templates, email templates, email or document letterhead templates, etc. The visual indicia may be embedded in these templates at the time of creating an electronic document, or templates may be created as defaults. The visual indicia may be embedded in other electronic documents in other ways which are appropriate to those electronic documents, such as by using a computer software program, database, or databases to automatically embed the visual indicia in said electronic documents.

The recipient of the electronic document will normally activate the visual indicia by pointing and clicking with a computer “mouse.” This is typical, but other means of activating the visual indicia will be apparent to persons of ordinary skill in the art. For example, instead of clicking a mouse, the recipient may tap a touch pad or use another computer interface device.

Call Request Page

When the recipient clicks on the visual indicia, the Call Request Page appears on the recipient's computer screen, presenting to the recipient the instant capability of a telephone connection with the sender.

Whether it is a graphic button, a hypertext link, or a URL, in the present embodiment, the visual indicia of the sender of the electronic document links to the same Call Request Page, which will be identified with that sender. Although the Call Request Page is identified with the sender of the electronic document, each sender can have as many different Call Request Pages (and therefore visual indicia linking to each) as they wish.

The Call Request Page is unique to each sender. Its URL address may contain a unique identifying number and/or letter sequence.

In the present embodiment, the Call Request Page may display a message offering the capability of a telephone connection with the sender using words which may include, but are not limited to, “Instant Live Talk,” “Instant LiveTalk,” “Call Me,” “Call,” “Click to Call,” “Make My Phone Ring,” “Call Me Now,” “We'll Call You For Free,” “Click Here to Talk to a Live Person,” or any other words which indicate that the recipient of the electronic document is requesting to speak, or may speak, with the sender of the electronic document.

In the present embodiment, the Call Request Page may also, at the option of the sender, contain the sender's company name, logo, graphic, or other company image, message, or other information. This logo, etc., may be easily added to the Call Request Page, or changed at will, by using an Electronic Front Office (see below).

The Call Request Page has the purpose of gathering information (at least the phone number of the recipient) which may also include, but is not limited to, the recipient's name, email address, and the time interval—ranging from “now” to 24 hours later—when they wish to initiate a telephone connection with the sender. In the present embodiment, the recipient is asked to enter this information on the Call Request Page and then to click a send button (which may be labeled with words including but not limited to “Instant Live Talk,” “Instant LiveTalk,” “Call Me,” “Call,” “Click to Call,” “Make My Phone Ring,” “Call Me Now,” “We'll Call You For Free,” “Click Here to Talk to a Live Person,” or any other words which indicate that the recipient of the electronic document is requesting to speak, or may speak, with the sender of the electronic document.)

When the recipient clicks the send button on the Call Request Page, this information is sent to the Electronic Document Call Back System servers for the purpose of establishing a telephone connection with the sender, as well as for the purpose of sending via email certain information to the recipient as well as to the sender.

Electronic Front Office (EFO)

An Electronic Front Office (EFO) may be an online interface in the form of a Web page or series of Web pages, which allows the sender to easily make changes in the operation of certain aspects of the Electronic Document Call Back System, which in the preferred embodiment may include:

1. The capability of creating a “custom email” response to the recipient, which can be created and changed at any time by the sender using an Electronic Front Office, and which may appear as an addition to or instead of an automatic “thank you” email;

2. “Edit Page Name”—the capability of personalizing part of the hypertext link to include the sender's name, company name, or any other identifying words they wish (see Definition of Visual Indicia above);

3. The capability of changing the “Callback Number”—the phone number to which the recipient will be connected;

4. The capability of changing the sender's email address to which the recipient's contact information will be sent;

5. The capability of changing the company name and Web site address which will appear in the “thank you” email to be sent to the recipient;

6. The capability of changing the hours of operation (and time zone) during which calls will be accepted by the sender;

7. The capability of specifying the countries or regions of the world from which the sender is willing to accept calls from recipients in those countries or regions of the world.

8. The capability of changing the logo, etc., which will appear on the Call Request Page;

9. The capability of the sender to view their account information;

10. Logging off and saving changes;

11. A fraud protection feature that ensures that the sender only receives inquiries from a domain name specified by said sender.

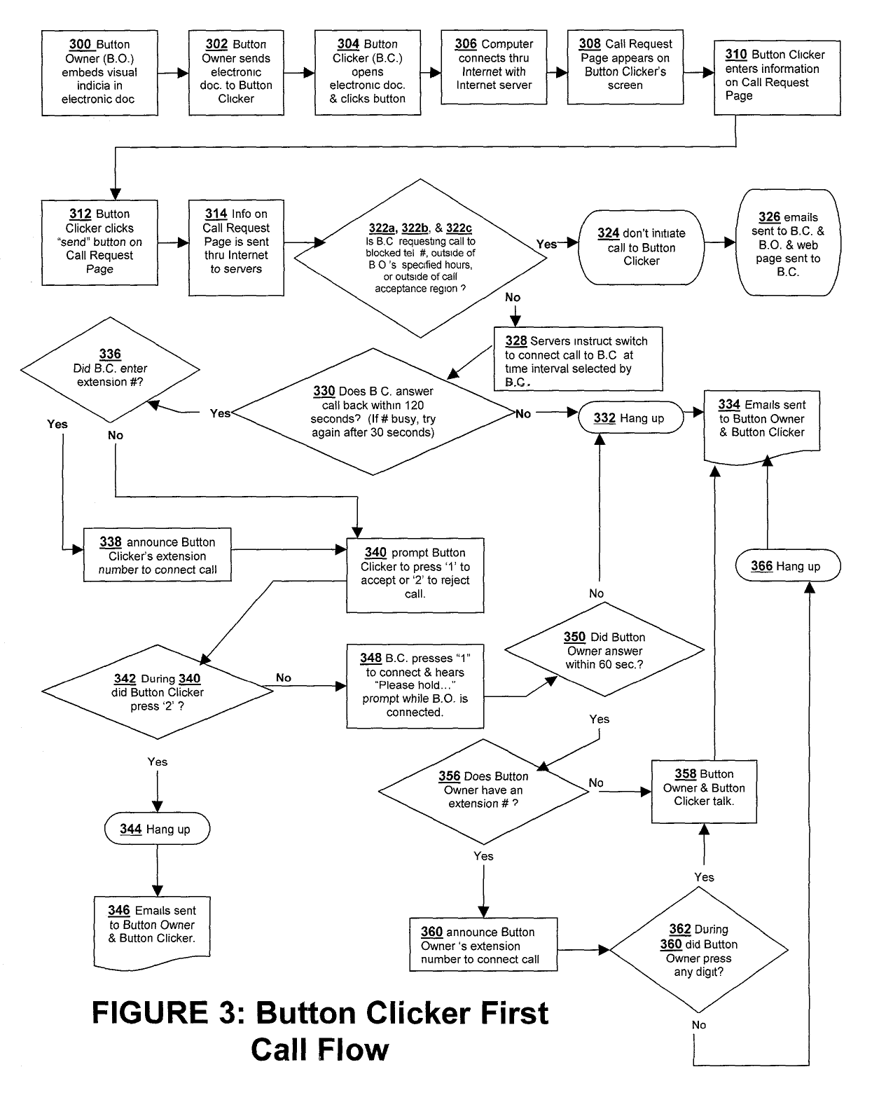

### FIG. 3: “Button Clicker First” Call Flow

FIG. 3 shows a flow chart of events that occur during a typical Electronic Document Call Back System sequence wherein the “button clicker,” (i.e., the recipient of the electronic document), is connected first in the call back sequence, and then the “button owner,” (i.e., the sender of the electronic document), is after this connected with the button clicker.

The “button clicker first” sequence starts with the button owner embedding a visual indicia in an electronic document (block 302). As defined in FIG. 2, in the present embodiment a visual indicia in the electronic document may be, among other possibilities, a graphic button, or a hypertext link. This hypertext link may be a word sequence indicating that clicking upon it will create a telephone connection with the button owner, or it may be a URL containing a unique identifying number and/or letter sequence which may be customized as a name or phrase of the button owner's choice by using an Edit Page Name function of an Electronic Front Office (EFO) or other means of changing the unique identifying number and/or letter sequence in the URL of the hypertext link (see Notes on FIG. 2)].

Whether it is a graphic button, a hypertext link, or a URL, in the present embodiment, the visual indicia of the sender of the electronic document links to the same Call Request Page, which will be identified with that sender. Although the Call Request Page is identified with the sender of the electronic document, each sender can have as many different Call Request Pages (and therefore visual indicia linking to each) as they wish.

The button owner then sends the electronic document to the recipient (the “button clicker”) (block 304). The button clicker opens the electronic document and clicks on the button (or hypertext link or URL) (block 306). The clicking on the button or hypertext link causes the Web browser software on the button clicker's computer to launch; the computer connects through the Internet with the Electronic Document Call Back System Internet server (block 308) (where the Call Request Page is located); and the button owner's Call Request Page appears (block 310) on the button clicker's computer screen.

The button clicker enters on this Call Request Page some information (block 312), at least his or her phone number, and which may also include his or her name, email address, and time of desired call back.

The button clicker is then asked to click a “send” button (which may be labeled as described in the Definition of the Call Request Page in the FIG. 2 section above) upon the Call Request Page. When the “send” button is clicked (block 314), the information which has been entered on the Call Request Page is sent through the Internet to the Electronic Document Call Back System servers (block 316). This information also includes a unique identifying number and/or letter sequence corresponding with the URL of the specific Call Request Page and specific button owner.

After clicking the “send” button on the Call Request Page, the Electronic Document Call Back System servers may check to see if any of the following conditions is true:

a) Does the button clicker's telephone number appear in the permanent call blocking table (blacklisting) (decision block 322a)?

b) Is the button clicker initiating a call request outside of the business hours which the button owner has specified at the time of account set up or subsequently on the EFO (Electronic Front Office) (decision block 322b)?

c) Has the button clicker entered a phone number at which to be called back which is outside of the Call Acceptance Region which the button owner has specified at the time of account set up (decision block 322c)?

If the answer to any of these questions is “yes,” then the call is not put through (block 324), and the Electronic Document Call Back System servers send a Web page and an email message to the button clicker through the Internet stating that no call was connected and that it was because either the button clicker entered a blacklisted phone number, initiated a call request outside of the button owner's business hours, or entered a phone number outside of the button owner's specified Call Acceptance Region (block 326).

(The Web page and email sent to the button clicker are appropriate to the situation: a, b, or c above.) The button owner is sent by the Electronic Document Call Back System servers an email with the details of the button clicker's failed call request and the reason for the call not being connected (a, b, or c above) (block 326).

If the answer to all of the questions, a, b, and c above, following the button clicker's request for a call by completing the Call Request Page, is “no,” the Electronic Document Call Back System servers check the time interval that the button clicker has selected on the Call Request Page to connect with the button owner. At that button clicker-specified time interval (which may range from “now” to 24 hours later), a call (hereinafter called the “call back”) is initiated by the Electronic Document Call Back System telecom switch to the telephone number that the button clicker entered on the Call Request Page (block 328).

The button clicker is given 120 seconds to answer the call back (decision block 330). If the button clicker does not answer within 120 seconds, the Electronic Document Call Back System servers instruct the Electronic Document Call Back System telecom switch to hang up (block 332), and an email is sent by the Electronic Document Call Back System servers (block 334) to the button owner showing details of the call attempt, including the information the button clicker supplied on the Call Request Page, which may be imported into the contact database of a contact management software program. An email is also sent by the Electronic Document Call Back System servers (block 334) to the button clicker showing details of the call attempt along with the optional “custom email” message which can be created by the button owner (explained under FIG. 2).

(If the phone number that the button clicker provided is busy, then the Electronic Document Call Back System servers instruct the Electronic Document Call Back System telecom switch to try again after 30 seconds.)

If the phone number that the button clicker entered on the Call Request Page does answer within 120 seconds (decision block 330), the Electronic Document Call Back System servers check to see if the button clicker also entered an extension number on the Call Request Page (decision block 336). If “yes,” the Electronic Document Call Back System servers request this extension number both by announcing the extension number with a voice prompt (so that the call can be routed to the correct extension if the button clicker has a live human operator) and by emitting DTMF tones (“touch tones”) so that the call can be routed to the correct extension if the button clicker has an IVR system (a menu-driven automatic call routing system) (block 338).

To facilitate the connection of the call back to the button clicker's correct extension number, the voice prompt may also include a message stating a phrase such as, “This is the call you requested from ‘the electronic document call back system’ [using here the trade name of the Electronic Document Call Back System]. Press the number “1” now to accept and then transfer this call to extension number [button clicker's extension number]”

If “no” (the button clicker does not have an extension), once the button clicker answers the telephone, the Electronic Document Call Back System servers, using voice prompts, present the option of pushing “1” to accept the call back or “2” to reject the call back (this message will be repeated 5 times). (block 340)

If, during the “push 1 to accept and 2 to reject” prompt, the button clicker presses “2” (decision block 342), then the Electronic Document Call Back System servers instruct the Electronic Document Call Back System telecom switch to hang up (block 344), no more calls are attempted, and an email is sent by the Electronic Document Call Back System servers (block 346) to the button owner showing details of the call attempt, including the information the button clicker supplied on the Call Request Page, which may be imported into the contact database of a contact management software program. An email is also sent by the Electronic Document Call Back System servers (block 346) to the button clicker showing details of the call attempt along with the optional “custom email” message which can be created by the button owner.

If, during the “push 1 to accept and 2 to reject” prompt, the button clicker presses “1,” the button clicker hears a “Please hold . . . ” prompt while the button owner is being called (block 348). If the button owner does not answer within 60 seconds (decision block 350), the Electronic Document Call Back System servers instruct the Electronic Document Call Back System telecom switch to hang up (block 332) and an email is sent by the Electronic Document Call Back System servers (block 334) to the button owner showing details of the call attempt, including the information the button clicker supplied on the Call Request Page, which may be imported into the contact database of a contact management software program. An email is also sent by the Electronic Document Call Back System servers (block 334) to the button clicker showing details of the call attempt along with the optional “custom email” message which can be created by the button owner.

After the button clicker receives the call back and is waiting on the line, if the button owner does answer within 60 seconds (decision block 350), then the Electronic Document Call Back System servers check to see if the button owner has an extension number (decision block 356). If “no,” then the call with the button clicker is put through to the button owner, no extension number announcement is made, and they talk (block 358). An email is sent by the Electronic Document Call Back System servers (block 334) to the button owner showing details of the call attempt, including the information the button clicker supplied on the Call Request Page, which may be imported into the contact database of a contact management software program. An email is also sent by the Electronic Document Call Back System servers (block 334) to the button clicker showing details of the call attempt along with the optional “custom email” message which can be created by the button owner.

If “yes” (the button owner does have an extension number) (decision block 356), then the Electronic Document Call Back System servers announce the extension number of the button owner by playing a voice prompt, such as “extension [button owner's extension number]” at the same time as generating the DTMF tones (“touch tones”) which correspond to the button owner's extension number. (block 360).

To facilitate the connection of the call to the button owner's correct extension number, the voice prompt may also include a message stating a phrase such as, “This is a call from ‘the electronic document call back system’ [using here the trade name of the Electronic Document Call Back System]. Please press the number “1” now to accept and then transfer this call to extension number [button owner's extension number]”

By the Electronic Document Call Back System servers' generating both the voice prompt and the DTMF (“touch tones”) which correspond to the button owner's extension number, this permits the call back to be directed to the appropriate extension number at the button owner's place of business. If the button owner has a human-staffed receptionist, then the call back will be announced by the Electronic Document Call Back System servers' playing a voice prompt with the digits of the button owner's extension number so that the human receptionist can route the call back to the correct extension number. If the button owner has an IVR system (a menu-driven automatic call routing system), then the Electronic Document Call Back System servers will emit the DTMF (“touch tones”) which correspond to the digits of the button owner's extension number so that the IVR will automatically route the call back to the correct extension.

If, during the repetition of the extension prompt, the button owner presses any digit on their telephone key pad (decision block 362), that will shut off the extension number prompt, and then the button owner and button clicker talk (block 358). An email is sent (block 334) by the Electronic Document Call Back System servers to the button owner showing details of the call request, including the information the button clicker supplied on the Call Request Page, which may be imported into the contact database of a contact management software program. An email is also sent (block 334) by the Electronic Document Call Back System servers to the button clicker showing details of the call request along with the optional “custom email” message which can be created by the button owner.

If, during the extension prompt, the button owner does not press within two minutes any digit (decision block 362), then the Electronic Document Call Back System servers instruct the Electronic Document Call Back System telecom switch to hang up (block 366), and send an email (block 334) to the button owner showing details of the call attempt, including the information the button clicker supplied on the Call Request Page, which may be imported into the contact database of a contact management software program. An email is also sent (block 334) by the Electronic Document Call Back System servers to the button clicker showing details of the call attempt along with the optional “custom email” message which can be created by the button owner.

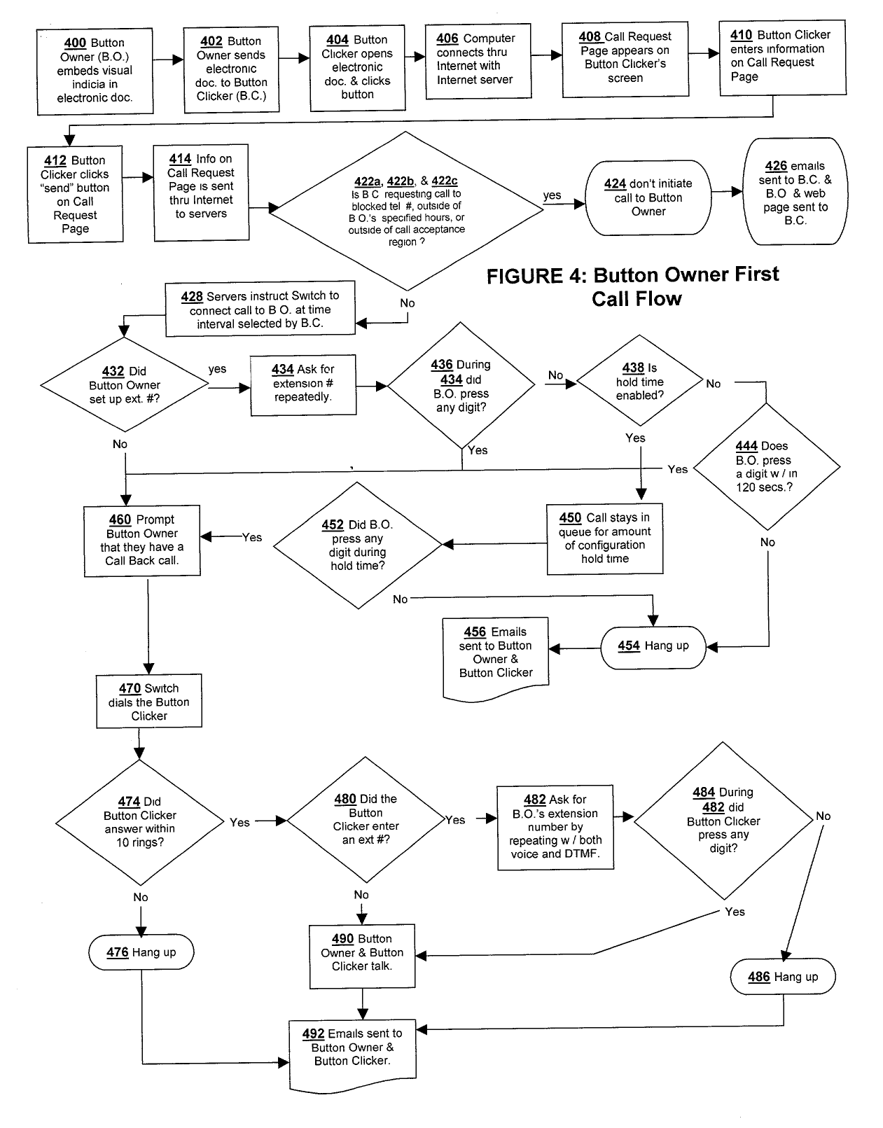

### FIG. 4: “Button Owner First” Call Flow

FIG. 4 shows a flow chart of events that occur during a typical call back system sequence wherein the “button owner” (i.e., the sender of the electronic document) is connected first in the call back sequence, and then the “button clicker” (i.e., the recipient of the electronic document) is after this connected with the button owner.

This “button owner first” call flow is an alternative to the “button clicker first” option described in FIG. 3 and which the button owner may wish to choose at the time that they first set up their Electronic Document Call Back System or any time thereafter. It affords the button clicker the convenience (called, in the present embodiment, “No Hold”) of being connected to the telephone call with the button owner only when the button owner has a live person available on the line in order to talk directly with the button clicker.

The “button owner first” sequence starts with the button owner embedding a visual indicia in an electronic document (block 302). As defined in FIG. 2, in the present embodiment a visual indicia in the electronic document may be, among other possibilities, a graphic button or a hypertext link. This hypertext link may be a word sequence indicating that clicking upon it will create a telephone connection with the button owner, or it may be a URL containing a unique identifying number and/or letter sequence which may be customized as a name or phrase of the button owner's choice by using an Edit Page Name function of an Electronic Front Office (EFO) or other means of changing the unique identifying number and/or letter sequence in the URL of the hypertext link (see Notes on FIG. 2)].

Whether it is a graphic button, a hypertext link, or a URL, in the present embodiment, the visual indicia of the sender of the electronic document links to the same Call Request Page, which will be identified with that sender. Although the Call Request Page is identified with the sender of the electronic document, each sender can have as many different Call Request Pages (and therefore visual indicia linking to each) as they wish.

The button owner then sends the electronic document to the recipient (the “button clicker”) (block 404). The button clicker opens the electronic document and clicks on the button (or hypertext link) (block 406). The clicking on the button or hypertext link causes the Web browser software on the button clicker's computer to launch; the computer connects through the Internet with the Electronic Document Call Back System Internet server (block 408) (where the Call Request Page is located); and the button owner's Call Request Page appears (block 410) on the button clicker's computer screen.

The button clicker enters on this Call Request Page some information (block 412), at least his or her phone number, and which may also include his or her name, email address, and time of desired call back.

The button clicker is then asked to click a “send” button (which may be labeled as described in the Definition of the Call Request Page in the FIG. 2 section above) upon the Call Request Page. When the “send” button is clicked (block 314), the information which has been entered on the Call Request Page is sent through the Internet to the Electronic Document Call Back System servers (block 316). This information also includes a unique identifying number and/or letter sequence corresponding with the URL of the specific Call Request Page and specific button owner.

After clicking the “send” button on the Call Request Page, the Electronic Document Call Back System servers check to see if any of the following conditions is true:

a) Does the button clicker's telephone number appear in the permanent call blocking table (blacklisting) (decision block 422a)?

b) Is the button clicker initiating a call request outside of the business hours which the button owner has specified at the time of account set up or subsequently on the EFO (Electronic Front Office) (decision block 422b)?

c) Has the button clicker entered a phone number at which to be called back which is outside of the Call Acceptance Region which the button owner has specified at the time of account set up (decision block 422c)?

If the answer to any of these questions is “yes,” then the call is not put through (block 424), and the Electronic Document Call Back System servers send a Web page and an email message to the button clicker stating that no call was connected and that it was because either the button clicker entered a blacklisted phone number, initiated a call request outside of the button owner's Business hours, or entered a phone number outside of the button owner's specified Call Acceptance Region (block 426). (The Web page and email sent to the button clicker are appropriate to the situation: a, b, or c above.) The button owner is sent by the Electronic Document Call Back System servers an email with the details of the button clicker's failed call request and the reason for the call not being connected (a, b, or c above) (block 426).

If the answer to all of the questions a, b, and c above, following the button clicker's request for a call by completing the Call Request Page, is “no,” a call (herein called the “call back”), is initiated by the Electronic Document Call Back System servers to the button owner first (block 428) at the time interval (which may range from “now” to 24 hours later) which was selected by the button clicker on the Call Request Page [assuming that the button owner has requested button owner first call flow at the time of account set-up or, subsequently, on an Electronic Front Office (EFO)].

If the button owner, either to enable the “No Hold” convenience or for any other reason, requested at the time of account set-up or subsequently, that call back connections should be sent to a specified extension number at the button owner's facility, (decision block 432), when connecting the call to the button owner, the Electronic Document Call Back System servers announce that extension number every five seconds with a repeated voice synthesized prompt (block 434). If during the repetition of the extension number announcement the button owner does not press a digit on his or her telephone keypad (which would have emitted DTMF tones) (decision block 436), the system checks to see if a “No Hold” hold time has been enabled (decision block 438).

If no hold time is enabled and if, after the repetition of the extension number prompt for 120 seconds (block 444) the button owner does not press any digit, then the Electronic Document Call Back System servers hang up (block 454) and an email is sent (block 456) by the Electronic Document Call Back System servers to the button owner showing details of the call attempt, including the information the button clicker supplied on the Call Request Page, which may be imported into the contact database of a contact management software program. An email is also sent (block 456) by the Electronic Document Call Back System servers to the button clicker showing details of the call attempt along with the optional “custom email” message which can be created by the button owner.

If, on the other hand, hold time is enabled, the call stays in queue for the length of hold time that was chosen by the button owner (block 450). During the hold time the Electronic Document Call Back System servers check to see if the button owner presses any digit on his or her telephone keypad (which emits DTMF tones) (decision block 452).

If “yes,” (any digit is pressed by a sales representative or other employee who answers the button owner's telephone) the Electronic Document Call Back System servers generate a voice prompt announcing to the button owner that they have a call from the Electronic Document Call Back System (block 460). Then, the Electronic Document Call Back System servers instruct the Electronic Document Call Back System telecom switch to dial (block 470) the telephone number that the button clicker has entered on the Call Request Page.

To facilitate the connection of the call to the button owner's correct extension number, the voice prompt may also include a message stating a phrase such as, “This is a call from ‘the electronic document call back system’ [using here the trade name of the Electronic Document Call Back System]. Please press the number “1” now to accept and then transfer this call to extension number [button owner's extension number]”

If “no” (no digit is pressed by a sales representative or other employee who answers the button owner's telephone during the length of hold time which the button owner has specified at the time of account set-up or subsequently) then the Electronic Document Call Back System servers hang up (block 454) and an email is sent (block 456) by the Electronic Document Call Back System servers to the button owner showing details of the call attempt, including the information the button clicker supplied on the Call Request Page, which may be imported into the contact database of a contact management software program. An email is also sent (block 456) by the Electronic Document Call Back System servers to the button clicker showing details of the call attempt along with the optional “custom email” message which can be created by the button owner.

After block 470, wherein the Electronic Document Call Back System servers instruct the Electronic Document Call Back System telecom switch to dial the telephone number that the button clicker has entered on the Call Request Page, if the button clicker does not answer the call within 10 rings (decision block 474), the Electronic Document Call Back System servers hang up (block 476), and an email is sent (block 492) by the Electronic Document Call Back System servers to the button owner showing details of the call attempt, including the information the button clicker supplied on the Call Request Page, which may be imported into the contact database of a contact management software program. An email is also sent (block 492) by the Electronic Document Call Back System servers to the button clicker showing details of the call attempt along with the optional “custom email” message which can be created by the button owner.

If the phone number the button clicker entered on the Call Request Page is answered within ten rings (decision block 474), the Electronic Document Call Back System servers check to see if the button clicker entered an extension number on the Call Request Page (decision block 480).

If the button clicker does not have an extension, then the Electronic Document Call Back System servers connect the calls and the button clicker and button owner talk (block 490). An email is sent (block 492) by the Electronic Document Call Back System servers to the button owner showing details of the call attempt, including the information the button clicker supplied on the Call Request Page, which may be imported into the contact database of a contact management software program. An email is also sent (block 492) by the Electronic Document Call Back System servers to the button clicker showing details of the call attempt along with the optional “custom email” message which can be created by the button owner.

If the button clicker does have an extension number (and entered it on the Call Request Page), the Electronic Document Call Back System servers announce the extension number by repeating a voice synthesized prompt (block 482) so that a human operator (at the button clicker's telephone switchboard) who answers the call back can route it to the button clicker's extension, as well as by generating the DTMF tones corresponding to the extension number so that the call back can be automatically routed to the button clicker's extension in case the button clicker's phone system utilizes a digital menu-driven automatic call-routing system.

To facilitate the connection of the call back to the button clicker's correct extension number, the voice prompt may also include a message stating a phrase such as, “This is the call you requested from ‘the electronic document call back system’ [using here the trade name of the Electronic Document Call Back System], press the number “1” now to accept and then transfer this call to extension number [button clicker's extension number]”

If, during the repetition of the extension number announcement, any person who answers the button clicker's phone number does NOT press a digit on his or her telephone keypad (which would have emitted DTMF tones) (decision block 484), the Electronic Document Call Back System servers hang up (block 486), and an email is sent (block 492) by the Electronic Document Call Back System servers to the button owner showing details of the call attempt, including the information the button clicker supplied on the Call Request Page, which may be imported into the contact database of a contact management software program. An email is also sent (block 492) by the Electronic Document Call Back System servers to the button clicker showing details of the call attempt along with the optional “custom email” message which can be created by the button owner.

If, during the repetition of the extension number announcement, any person who answers the button clicker's phone number DOES press a digit on his or her telephone keypad (which will emit DTMF tones and will stop the repetition of the extension number announcement) (decision block 484), then the button owner and button clicker talk (block 490), and an email is sent (block 492) by the Electronic Document Call Back System servers to the button owner showing details of the call attempt, including the information the button clicker supplied on the Call Request Page, which may be imported into the contact database of a contact management software program. An email is also sent (block 492) by the Electronic Document Call Back System servers to the button clicker showing details of the call attempt along with the optional “custom email” message which can be created by the button owner.

### FIG. 5: Physical Equipment and Linkages of the Electronic Document Call Back System

FIG. 5 is a schematic diagram showing the physical equipment and their linkages which are needed to complete the Electronic Document Call Back System.

The Electronic Document Call Back System starts with a button owner setting up an Electronic Document Call Back System account. The data from the account set-up (including call back number, email address, Web site, hours of operation, etc.) is sent to the Electronic Document Call Back System data processing center whose people enter the data into the Business Control Server (512) for storage in the Database (514). The Business Control Server (512) then directs the Database (514) to randomly assign a unique identifying number (called the PIN alias) which corresponds to the button owner's account.

The Electronic Document Call Back System provides the button owner a URL (containing a unique identifying number and/or letter sequence) that links to a Call Request Page specific to the button owner. This link can be embedded or placed as a visual indicia in any electronic document (which may include but not be limited to emails, word processing documents, software programs, etc.—see “Background of the Invention”).

The visual indicia may be in the form of a URL, a hypertext link, or a graphic button (there may be other types of visual indicias). The hypertext link may be a word sequence indicating that clicking upon it will create a telephone connection with the button owner, or it may be a URL containing a unique identifying number and/or letter sequence which may be customized as a name or phrase of the button owner's choice by using an Edit Page Name function of an Electronic Front Office (EFO) or other means of changing the unique identifying number and/or letter sequence in the URL of the hypertext link (see Notes on FIG. 2)].

Whether it is a graphic button, a hypertext link, or a URL, in the present embodiment, the visual indicia of the sender of the electronic document links to the same Call Request Page, which will be identified with that sender. Although the Call Request Page is identified with the sender of the electronic document, each sender can have as many different Call Request Pages (and therefore visual indicia linking to each) as they wish.

For our purposes here we will refer to the visual indicia as a “button”. The hypertext link as a URL would typically be placed in any ordinary text email or other electronic document. The graphic button, or the hypertext link as a phrase linking to the URL of the Call Request Page, would typically be placed in a “rich media” email or other electronic document which supports graphical content. Whichever form the visual indicia is in, when it is activated by the button clicker, it will link to a Call Request Page specific to the button owner.

The button owner uses his or her computer (502) to send an electronic document containing the button through the Internet (506) to a button clicker's computer (504). The button clicker clicks on the button in the electronic document.

If the Web browser on the button clicker's computer is not active, then the clicking on the button causes the Web browser software to launch. Once the Web browser software is active, then the button clicker's computer (504) connects through the Internet (506) with the Electronic Document Call Back System Internet server (508) and through the Electronic Document Call Back System firewall (510) to the Business Control Server (512). The Business Control Server (512) communicates with the Database (514) and generates “on the fly” the Call Request Page. The Electronic Document Call Back System Internet server (508) generates the code for the Call Request Page, and the browser software of the button clicker's computer (504) puts the code into the form that the button clicker actually sees on the computer screen. In this way, the button owner's Call Request Page, which has fields to fill in, appears on the button clicker's computer screen (504).

The button clicker enters or indicates on this Call Request Page some information: at least his or her phone number, but which may also include his or her name, email address, extension number, and time interval of desired call back.

The button clicker is then asked to click a “send” button (which may be labeled as described in the Definition of the Call Request Page in the FIG. 2 section above) upon the Call Request Page.

When the “Call” button is clicked, the information on the Call Request Page is sent through the Internet (506) to the Electronic Document Call Back System Internet server (508). This information, or data packet, contains all the relevant information about the button clicker and the button owner, including the PIN alias number.

The data packet goes through the firewall (510) to the Business Control Server (512). The Business Control Server stores the information about the button clicker (email address, phone number, name, date and time of call request, and time interval of desired call back) in a log. Any information that comes in is immediately logged to the Database (514). The Database is a distributed database located on the Electronic Document Call Back System Intranet, and it functions as a random access storage unit.

The Business Control Server (512) then parses out the information as it verifies the button owner's account and the call request data. The Business Control Server (512) checks the Database (514) to determine the following:

1. Is the account that has sent data still a valid account?

2. Does the account have enough credit for a call?

3. Is the call request within the hours of operation that button owner has designated?

4. Is button clicker's number NOT blacklisted?

5. Is button clicker's number in the rate table (the Call Acceptance Region from which calls will be accepted) for button owner's account?

6. Is button clicker number NOT a 900 number or other blocked number?

If the answer to any of these questions is “no,” then the call is not put through. If all answers are yes, then the data from the Business Control Server (512) is transferred to the Switch Control Server (516) as a call set-up request.

The Switch Control Server (516) sends, at the proper time (the time interval that the button clicker has indicated for the call request, i.e., now, in 1 minute, in 5 minutes, etc., up to 24 hours), a request to the Electronic Document Call Back System Central Office (CO) Class switch (518) to place a call to the button clicker's telephone (524) and then to the button owner's telephone (522) [or vice versa, depending on the call flow the button owner has specified at the time of account set-up or subsequently on an Electronic Front Office (EFO)].

In the case of “button clicker first” call flow, this happens in the following way:

The Business Control Server (512) communicates with the CO switch (516) through an Ethernet connection in the Electronic Document Call Back System Intranet, and the CO switch (516) initiates a call through the Public Switch Telephone Network (PSTN) (520) to the button clicker.

The Switch Control Server (516) waits for answer supervision (i.e., for the phone to be answered—whether by a live person or by an automated voice mail system) from the button clicker (524). When the Switch Control Server (516) receives answer supervision from the button clicker, it plays a prompt indicating that the source of the call back is the call request the button clicker just initiated. Then the Switch Control Server (516) causes the CO switch (518) to put the call to the button clicker on hold momentarily while it initiates a new call to the button owner. After the button owner picks up his or her telephone (522), there are two separate calls at this point. As soon as the call to the button owner's telephone (522) has been placed, the CO switch (518) bridges (conferences) the on-hold call to the button clicker with the call to the button owner.

The Switch Control Server (516) notifies the Business Control Server (512) that a call has been established, and it waits for the hang-up of either the button clicker or the button owner.

When the Business Control Server (512) is notified that a call has been established, it starts a record that will soon turn into a billing record. It also starts rating the call, and if, for some reason, the call is established too long and the credit of the button owner runs out, the call will be terminated.

Once the status of the call is determined, the Business Control Server (512) sends a request (along with details about the call request) to the Internet Email Relay (526) to send two emails through the Internet: one to the button clicker's computer (504) and one to the button owner's computer (502). In every case these two emails are sent, whether the call is successful (a completed call) or incomplete (e.g., the call is not put through because the request is made outside of the button owner's business hours).

All the information that is put into each email is generated by the Business Control Server (512) to indicate dynamically the results of the call, button clicker information, and button owner information. The email to the button clicker thanks him or her for using the service, gives the time and date of the call request, and if the call was incomplete, explains the reason why the call was not put through. This “thank you” email can also contain a customizable message from the button owner. The “custom email” thus created can be automatically sent to the button clicker each time he or she clicks on the visual indicia, and the text in said custom email can be changed by the button owner, whenever desired, by using an Electronic Front Office online interface.

The email to the button owner may contain the valuable contact information that the button clicker has provided on the Call Request Page (name, telephone number, email address), the specific URL of the Call Request Page (which might be one of many that the button owner has, and will therefore indicate the specific area of interest of the button clicker), the time and date of the call request, and whether or not the call was successful or incomplete. This contact data may be imported into the contact database of a contact management software program.

Upon termination of a successful call, the Business Control Server (512) debits the credit of the button owner's account.

While the invention has been described with respect to specific embodiments by way of illustration, many modifications and changes will occur to those of ordinary skill in the art. For instance, telephone communication can occur with a conventional telephone instrument over conventional telephone lines, or, as will be apparent to those of ordinary skill in the art, can occur in other ways such as by internet telephony using a microphone, headset, and speakers. It is, therefore, to be understood that the appended claims are intended to cover all such modifications and changes as fall within the true scope and spirit of the invention.

What is claimed is:

1) Electronic Document Call Back System comprising:
a) means for displaying visual indicia in an electronic document sent by a sender to a recipient, the indicia indicating that activation of the indicia will initiate a telephone communication with the sender of said electronic document; and
b) means to engage a Web server, upon the activation of the indicia, for opening a computer screen on the recipient's computer, the screen containing an inquiry requesting information of at least the recipient's telephone number and also containing indicia indicating how to submit the information; and
c) the Web server being adapted to initiate telephone communication between the sender of said electronic document and the recipient of said electronic document in response to data obtained in the inquiry.

2) An Electronic Document Call Back System as claimed in claim 1, wherein:
a) the Web site contains a plurality of indicia for submitting information to initiate telephone communication regarding a respective plurality of matters on the Web site of the sender;
b) the computer screen showing only a specific one of the foregoing indicia that relates to a matter stated in the electronic document.

3) An Electronic Document Call Back System as claimed in claim 1, wherein:
a) the inquiry includes a timing option for an immediate or a delayed telephone communication; and
b) the Web server is adapted to initiate the telephone communication in accordance with the timing option.

4) An Electronic Document Call Back System as claimed in claim 1, wherein the electronic document comprises an email.

5) An Electronic Document Call Back System as claimed in claim 1, wherein the Web server initiates telephone communication by activating a telecom switch, the switch then calling the phone number of the sender, calling the phone number of the recipient, and bridging the two calls together.

6) An Electronic Document Call Back System as claimed in claim 1, wherein, in response to the inquiry, the Web server is adapted to send an email to the sender with at least the recipient's telephone number for contacting the recipient in a communication different from the Electronic Document Call Back System telephone communication.

7) An Electronic Document Call Back System as claimed in claim 1, wherein the Web server is capable of automatically sending the recipient a response email in response to the inquiry.

8.) An Electronic Document Call Back System as claimed in claim 1, wherein the visual indicia comprises one of a graphic button and a hypertext link.

9.) An Electronic Document Call Back System as claimed in claim 8, wherein the hypertext link comprises a word sequence indicating that clicking upon it will initiate a telephone communication with the sender of the electronic document.

10.) An Electronic Document Call Back System as claimed in claim 8, wherein the hypertext link comprises a URL including a unique identifying number and/or letter sequence.

11.) An Electronic Document Call Back System as claimed in claim 10, wherein the System is adapted to allow the unique identifying sequence to be customized as desired by the sender.

12.) An Electronic Document Call Back System as claimed in claim 1, wherein the sender can modify operation of the Electronic Document Call Back System using an online interface.

13.) An Electronic Document Call Back System as claimed in claim 1, wherein the electronic document comprises a Web site banner ad.
